(19) United States
(12) Patent Application Publication
(10) Pub. No.: US 2024/0064566 A1
(43) Pub. Date: Feb. 22, 2024

(54) DIRECTIONAL CONTENT DELIVERY THROUGH SLICING OF WIRELESS SPECTRUM

(71) Applicant: INTERNATIONAL BUSINESS MACHINES CORPORATION, ARMONK, NY (US)

(72) Inventors: Laura Wynter, Singapore (SG); Nirmit V Desai, Yorktown Heights, NY (US); MUDHAKAR SRIVATSA, White Plains, NY (US); CHAITANYA KUMAR, Singapore (SG)

(21) Appl. No.: 17/820,675

(22) Filed: Aug. 18, 2022

(51) Int. Cl. H04W 28/06; G10L 25/51; G06V 20/52; G06V 10/764; H04W 16/14

(52) U.S. Cl. CPC H04W 28/06; G10L 25/51; G06V 20/52; G06V 10/764; H04W 16/14

(57) ABSTRACT

A computer-implemented method, a computer system and a computer program product provide differentiated services to spectrum zones based on user activity. The method includes obtaining a current spectrum zone configuration for a physical environment from a server. The method also includes capturing activity data from the physical environment. The method further includes identifying an event of interest in the activity data, wherein the event of interest comprises network requirements. The method also includes determining that the network requirements of the event of interest are not satisfied by the current spectrum zone configuration for the physical environment. Lastly, the method includes modifying the current spectrum zone configuration based on the network requirements.

### BACKGROUND

Embodiments relate generally to the field of delivering services through telecommunications networks and more specifically, to slicing wireless spectrum into zones based on user activity and providing differentiated services to each zone or slice.

Advanced telecommunications architectures may allow administration and control of the electromagnetic spectrum at an extremely fine level. As an example, modern 5G networks may be capable of combining more antenna elements, which may in turn enable more extensive spatial multiplexing and directional beamforming techniques. As a result of this control, network spectrum may be sliced into highly directional zones and networks. In addition to the physical slicing of spectrum into zones, modern network architectures also provide support for creating virtual networks as overlay abstractions on top of physical networks, e.g., the concept of network slices in 5G networks. In network slicing, a physical network element or intelligent software may implement control, or orchestration, of one or more network slices and also maintain separately the actual data packets of the one or more network slices. The resulting slices of spectrum, or zones, may be assigned separate virtual networks that may each provide differentiated services to clients in specific locations.

### SUMMARY

An embodiment is directed to a computer-implemented method for providing differentiated services to spectrum zones based on user activity. The method may include obtaining a current spectrum zone configuration for a physical environment from a server. The method may also include capturing activity data from the physical environment. The method may further include identifying an event of interest in the activity data, where the event of interest comprises network requirements. The method may also include determining that the network requirements of the event of interest are not satisfied by the current spectrum zone configuration for the physical environment. Lastly, the method may include modifying the current spectrum zone configuration based on the network requirements.

In another embodiment, a machine learning model that classifies detected human activity based on importance is used to identify the event of interest in the activity data.

In a further embodiment, a machine learning model that predicts an impact of a modification to a wireless network is used to determine that the network requirements are not satisfied by the current spectrum zone configuration.

In yet another embodiment, the spectrum zone configuration may include one or more of a direction of an antenna and an output power level of an antenna.

In another embodiment, the capturing the activity data in the physical environment may include monitoring the physical environment with a microphone and identifying an audio cue in the physical environment, where the audio cue is selected from a group consisting of: one or more spoken keywords and acoustic vibrations from user movements.

In a further embodiment, the capturing the activity data in the physical environment may include monitoring the physical environment with a camera and identifying a visual cue in the physical environment, where the visual cue is selected from a group consisting of: a user movement, a movement of an object, and text displayed in captured video.

In yet another embodiment, the network requirements may include an increase in consumption of network resources above a threshold, where the increase may be caused by one or more of: a scheduled event and user activity.

In addition to a computer-implemented method, additional embodiments are directed to a system and a computer program product for providing differentiated services to spectrum zones based on user activity.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 depicts a block diagram of an example computer system in which various embodiments may be implemented.

FIG. 2 depicts a flow chart diagram for a process that provides differentiated services to spectrum zones based on user activity according to an embodiment.

### DETAILED DESCRIPTION

Network slicing is a form of virtualization that allows multiple logical networks to run on top of a shared physical network infrastructure. A distributed cloud network may share network resources with various slices to allow different users to multiplex over a single physical infrastructure. As an example, many devices may need to share a 5G network which may be allocated into slices. Network slicing may allow the physical network to be partitioned at an end-to-end level to group traffic, isolate data traffic and configure network resources at a macro level. A network slice may implement many virtual components that may be created and moved based on current demands at particular locations and an orchestrator process may continually change locations of virtual components to ensure network performance of services across multiple slices.

With respect to the physical deployment and maintenance of modern broadband cellular networks, known as 5G, a higher level of fine-grained control of network spectrum may be available. The 5G millimeter wave frequencies may allow more antennas to be combined, enabling more extensive spatial multiplexing, and as a result, directional beamforming. The 5G infrastructure may include a network controller device or may use a radio-access network intelligent controller (RIC), which is cloud software responsible for controlling and optimizing baseband communication functions on the network and may manage 5G network functions like network slicing and prioritizing communications based on bandwidth and latency and other factors. Such a wireless network controller may employ directional beamforming schemes, as well as vary frequency bands or power levels, to create or modify multiple zones of coverage within the wireless spectrum of a physical environment and these separate spectrum zones may also be assigned separate network slices. A current limitation of wireless network management and control may be that both spectrum zones and network slices may typically require pre-defined configuration and implementation, where differentiated services may be provided across multiple zones or slices, but an initial configuration may be required to begin setup or manual intervention may be needed to make changes to the configuration of the zones or slices.

It may be useful to provide an automated method or system that may identify network requirements based on some type of physical human activity and then modify the configuration of zones or slices based on those requirements. Such a method or system may enable provision of directional content through steerable antennas, e.g., modifying the angle with respect to ground and orientation. In an indoor location, or outdoor locations that may have sufficient separation between client infrastructure devices, multiple zones may be defined and varied content, e.g., images or audio or video, may be transmitted to each zone within the same indoor room. The ability to perform highly directional and precise beamforming and transmission may allow a higher density of multi-media usage to the physical environment.

In addition, physical human activity may be detected in the physical environment by determining movement of mobile devices using timing advance information, e.g., movement towards a camera in the local zone, acoustics and vibration signals, e.g., initiating a question via audio, movement and footsteps that result in vibrations, or physically raising a hand, e.g., using video. A detected “event of interest”, such as described above, may cause a spectrum zone, and likely a new network slice, to be created proactively to support higher bandwidth, low latency and low jitter requirements for bi-directional video delivery and screen sharing. Such a method may improve the provision of differentiated services between multiple zones and allow the network architecture to more closely align with the physical environment. Such a method or system may also improve the efficiency of network slice management, including the capabilities of a network orchestrator device or a RAN intelligent controller (RIC) in the case of software network management.

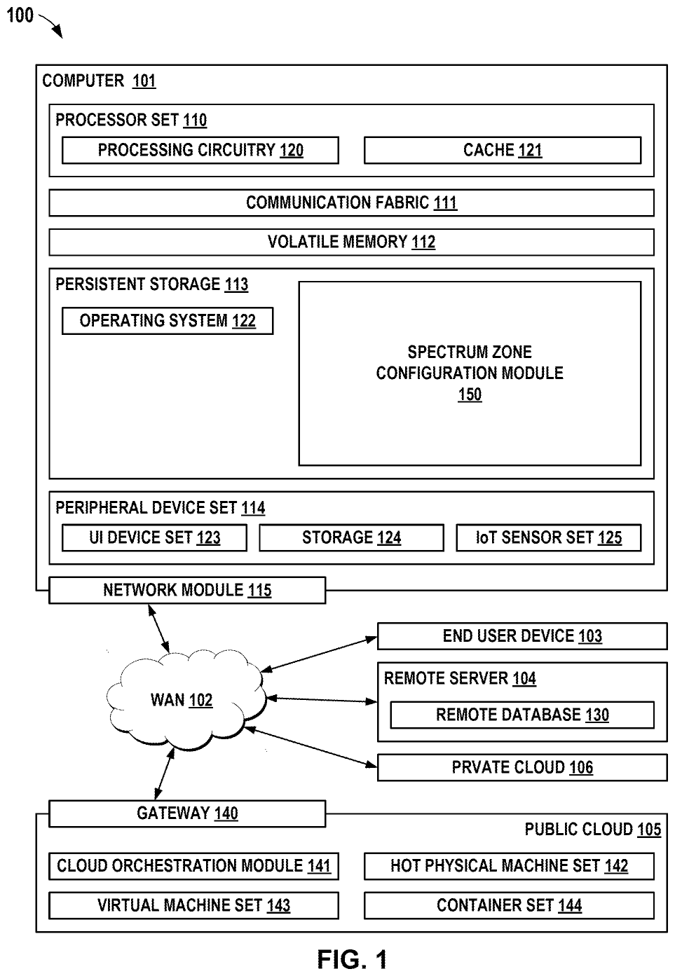

Referring to FIG. 1, computing environment 100 contains an example of an environment for the execution of at least some of the computer code involved in performing the inventive methods, such as spectrum zone configuration module 150. In addition to spectrum zone configuration module 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and spectrum zone configuration module 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in spectrum zone configuration module 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The code included in spectrum zone configuration module 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End User Device (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of VCEs will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

Computer environment 100 may be used to detect an “event of interest”, or user request, in a physical environment, predict network requirements for the detected event of interest or user request, and modify the spectrum zone configuration for the physical environment when the network requirements may not be satisfied by the current spectrum zone configuration. In particular, the spectrum zone configuration module 150 may modify the configuration of a wireless network to provide differentiated services to spectrum zones based on user activity. As an example, a group in one room of a building may be receiving a video stream while a user that may pass near the room may want a different service on their device and therefore may require a change to the spectrum, and subsequently a new network slice, to accommodate the service. Using one of the described techniques, a wireless network controller may detect an “event of interest”, or activity in the physical requirement that is determined to be of importance and represent a request for service, and modify, or “slice”, the wireless signal such that the device may now be in a new “spectrum zone”, and thus provide a new service. The new spectrum zone may also be assigned to a new network slice by the controller to enable the provision of service to the spectrum zone, and therefore the device.

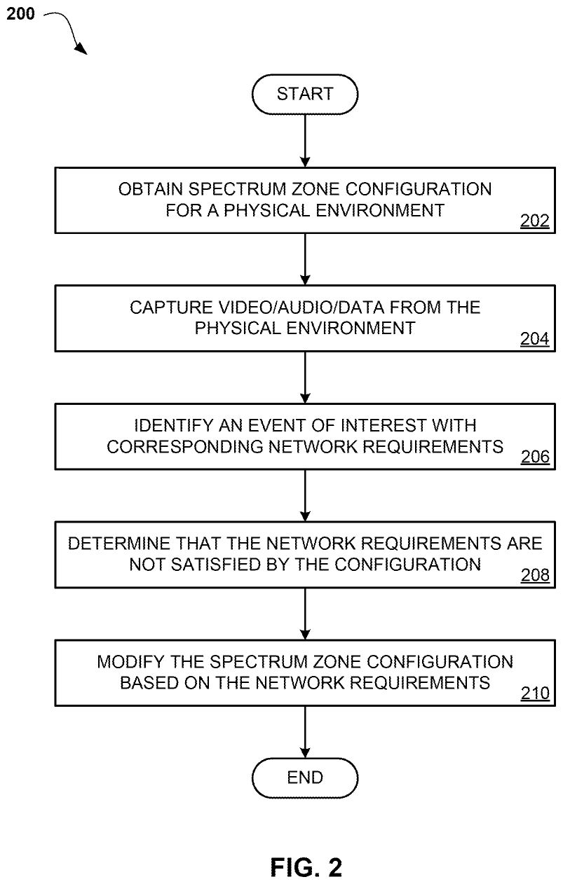

Referring to FIG. 2, an operational flowchart illustrating a process 200 that provides differentiated services to spectrum zones based on user activity is depicted according to at least one embodiment. At 202, a spectrum zone configuration may be obtained for the physical environment. The spectrum zone configuration may include the zones that presently exist in the physical environment and include information related to beam pattern control for massive multiple-input, multiple-output (MIMO) 5G systems. This information may include mapping, overlay, and integrating the physical entities of the physical environment into existing spectrum zones. The configuration may include details of the wireless network elements that may contribute to the existing spectrum zones, including the current power levels and orientation of antennas that may be present and any aspect of the capabilities of these wireless network elements. One of ordinary skill in the art may understand that there are many parameters involved in the provision of wireless network services.

At 204, activity data, including audio or video, or data from Internet of Things (IoT) devices or mobile devices that may be carried by a user, may be captured in the physical environment using an appropriate device. Examples of appropriate devices may include a microphone, fixed or non-fixed, that may be placed nearby to capture voices participating in a conversation that may be occurring in the physical environment, or a security camera that may be placed in the physical environment. A mobile device carried by the user may include a microphone or camera that may be used to capture activity data and may also include position data, e.g., GPS data, that may be used to determine an exact location and movements of the user. IoT devices that may be connected to a network may also include appropriate devices for capturing the activity data.

In an embodiment, a microphone may be in an “always-listening” mode, such that no prompt is required to begin audio capture and/or recording. The microphone may also, at the option of a user or administrator of the common area environment, be switched out of an “always-listening” mode (e.g., have the “always-listening” mode turned off). The same method of recording may be used with a camera to capture video in the physical environment. In addition to video or audio, devices within the physical environment may be set to transmit data, e.g., text messages that may be sent to or from at least one individual in the physical environment or position information about a user or an object within the physical environment. It is not necessary for there to be many devices under control but rather that there be a mechanism for accepting voice or video input, or text and other data, from the physical environment. For instance, microphones or cameras or other devices may be mounted within the physical environment in conspicuous or inconspicuous locations, such as within a collaborative space such as a conference room in an office or perhaps a cafeteria in an office building. One alternative to fixed devices in a location may be devices embedded in a smartphone or other mobile device that is carried by an individual within the physical environment, which may include a microphone or camera or even biometric data if the owner of the smartphone has a sensor attached and a corresponding application running on the smartphone. One of ordinary skill in the art would appreciate that one or more devices may be arranged in multiple ways to capture activities that may be occurring within a physical environment.

It should be noted that all collection of activity data from the physical environment that may personally identify any user or is sensitive in any other way requires the informed consent of all people whose information may be collected and analyzed for the purposes of the invention. Consent may be obtained in real time or through a prior waiver or other process that informs a subject that their information may be captured by a device or other process and that the information may be used to predict an appropriate spectrum slice, and accompanying network service, for that user. The information owner is free to decide at any time to revoke consent for use of sensitive information as these settings are permanently retained to keep the spectrum zone configuration module 150 updated with the latest information and also allow the owner of the information complete control over their informed consent to use sensitive information in the course of the invention. The consent described here may also refer to allowing some, or any, data relating to a user being sent to a local server, cloud server or any other location. The user has complete control on the transmission of information that may be sensitive or personally identify the owner of the information to any destination. In addition, any audio or video or other data that may be captured at this step may be stored, subject to the user consent restrictions described above and also contingent on whether the data may include sensitive information, to allow for a processing buffer in identifying an “event of interest”, or request for service in the physical environment.

It should be noted that the spectrum zone configuration may be dynamic and may be described by a schedule or may be event-based. For instance, event-based changes may occur in response to a decrease in Quality of Service (QoS) that may not be known in advance. These dynamic changes to the spectrum zone configuration may also be events of interest as described herein and the spectrum zone configuration itself, as controlled and maintained by the wireless network controller, may be included as activity data. The schedule or event-based algorithm that may be run on the wireless network controller, e.g., RIC, may also be used to produce matrices dynamically to orient multiple beams to a desired objective, e.g., the appropriate direction and capacity.

At 206, an event of interest may be identified in the captured activity data. Events of interest may take the form of audio cues, such as volume of speech or specific keywords that may be spoken by a user in the physical environment, e.g., initiating a question via audio, or acoustic vibrations that may be generated as a result of user movement in the physical environment, e.g., footsteps resulting in vibrations. Another form of event of interest may be a visual cue, such as a hand gesture or other user movement that may indicate a service request, e.g., raising a hand to ask a question of a speaker in a university class, or any event that may require changes to a wireless network to fulfill. Events of interest may be identified in the activity data through an understanding of movement of mobile devices using timing advance information, e.g., movement towards a camera in the local spectrum zone, acoustics and vibration signals, or object recognition in video data, including text that may appear in a video image using optical character recognition (OCR) techniques. All of these cases, e.g., timing advance info, acoustics/vibration data, a visual cue such as raising a hand, may prompt a change to network capacity. For instance, any of these cases may cause a low-bandwidth channel to prompt creation and deletion of network slices that support higher bandwidth, low latency and low jitter requirements for bi-directional video delivery and screen sharing, as mentioned below. Analogously, these cases may prompt creation and deletion of network slices to reduce capacity, if additional capacity is required elsewhere.

In an embodiment, a supervised machine learning model may be trained to classify events of interest by an importance that may be learned by the model. One or more of the following machine learning algorithms may be used: logistic regression, naive Bayes, support vector machines, deep neural networks, random forest, decision tree, gradient-boosted tree, multilayer perceptron. In an embodiment, an ensemble machine learning technique may be employed that uses multiple machine learning algorithms together to assure better classification when compared with the classification of a single machine learning algorithm. In this embodiment, training data for the model may include prior interactions between users and network elements, with an understanding of how the position of users or objects in the physical environment may affect the signal characteristics of the wireless network and the antenna elements. The training data may be collected from a single example user or a group of users, with user consent required prior to collection of any data from human users, as mentioned above, as well as data from a host of physical environments with varying objects and users. The classification results may be stored in a database so that the data is most current, and the output would always be up to date.

In another embodiment of this invention, events of interest may be determined from the spectrum zone configuration in tandem with an understanding of the physical environment. For instance, the spectrum zone configuration may have a schedule component such that during a particular time period, e.g., one hour, there should be 3 zones in an indoor room with sufficient separation to provide different content, then in the subsequent hour, there may need to be 4 zones in the same room, etc., throughout the day. In another example, an understanding of the current spectrum configuration at specific moments may represent an event of interest. For instance, if two zones are in close proximity such that interference may result, the wireless network controller, e.g., RIC, can receive an alert which may shift the location of one or more zones to improve the overall performance of the wireless network. Alternatively, a wireless network controller, e.g., RIC, may leverage network slices at different frequency bands to avoid interference between co-located transceivers. It is not required that an event of interest take any specific form, only that the system recognize a prompt from the physical environment, and understand the importance of the prompt and the network requirements that need to be satisfied.

It should also be noted that events of interest may be determined from failures and degradation of service that may be detected while service may be provided by a wireless network controller, e.g., RIC. For example, if the overall power or bandwidth for an entire indoor location, i.e., an entire wireless network or all spectrum zones, the controller may modify the spectrum zones, e.g., direction or power levels of antenna elements, to mitigate a problem. In the event of a partial failure or degradation, this may involve prioritizing the most important spectrum zones and shifting capacity to maintain QoS, or providing reduced-consumption options for those spectrum zones that can accommodate such a reduction, e.g., transmitting only the audio of a seminar when both audio and video have been transmitted previously or increasing bandwidth to a spectrum zone that may be transmitting a computer game so as to maintain game play without disruption. In an embodiment, it may be determined that network resource consumption may be increased above a threshold by user activity or possibly by a scheduled event, which may indicate an event of interest that may allow the network resources available to the spectrum zone to be increased and alleviate such increases.

At 208, it may be determined that the network requirements of the event of interest are not satisfied by the current network configuration. This step may be done at the same time as step 206 as the determination of network requirements may also yield an understanding of whether the current spectrum zone configuration may satisfy those requirements. It should be understood that requirements as described in this step may include Quality of Service (QoS) levels, which may be related to network characteristics such as bandwidth and latency, or requirements may include specific information about power levels, including a signal strength or alternatively the electrical power consumption, or the direction of specific antenna elements in the wireless network that may be contributing to the spectrum zone configuration.

In an embodiment, a supervised machine learning model, as described above, may be trained to predict or detect, an event of interest and to predict the network requirements of an event of interest, i.e., the impact that an event of interest may have on the current spectrum zone configuration, and the corresponding changes that may be needed in the wireless network when the spectrum zone configuration does not satisfy the network requirements. In this embodiment, training data for the model may include prior interactions between users and network elements, with an understanding of how the position of users or objects in the physical environment may affect the signal characteristics of the wireless network and the antenna elements. The training data may be collected from a single example user or a group of users, with user consent required prior to collection of any data from human users, as mentioned above, as well as data from a host of physical environments with varying objects and users. The model may be stored in a database so that the data is most current, and the prediction output would always be up to date.

At 210, the spectrum zone configuration, and by extension the network slice configuration, of the wireless network may be modified based on the requirements of the event of interest. As described above with respect to network requirements, algorithms in the wireless network controller, e.g., RIC, may also include policies to satisfy QoS requirements for each spectrum zone based on content needs, such as bandwidth or latency requirements. For instance, one spectrum zone may include a connection that is streaming video while another spectrum zone hosts a user playing an online interactive game. Such a policy may also include a requirement such as a limit on electrical power consumption for network elements in a specific location or on a network-wide level. These content requirements and changes may be pre-configured or may be estimated automatically by algorithms in the wireless network controller, e.g., RIC.

The modification of the venue network may include changes to the physical network elements, including the direction and power levels of the antennae in wireless networks. These changes may include modifying signal strength and coverage to create or modify spectrum zones using beamforming algorithms, as well as beam steering and beam switching.

Beamforming is the application of multiple radiating elements transmitting the same signal at an identical wavelength and phase, which combine to create a single antenna with a longer, more targeted stream which is formed by reinforcing the waves in a specific direction. The more radiating elements that make up the antenna, the narrower the beam.

Beam steering is achieved by changing the phase of the input signal on all radiating elements. Phase shifting allows the signal to be targeted at a specific receiver. An antenna may employ radiating elements with a common frequency to steer a single beam in a specific direction, but different frequency beams can also be steered in different directions to serve different users. The direction of a signal may be calculated dynamically by the source, or base station, as the endpoint moves, which may effectively track the user. If a beam cannot track a user, the endpoint may switch to a different beam, known as beam switching.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method for providing differentiated services to spectrum zones based on user activity, the method comprising:
obtaining a current spectrum zone configuration for a physical environment from a server;
capturing activity data from the physical environment;
identifying an event of interest in the activity data, wherein the event of interest comprises network requirements;
determining that the network requirements of the event of interest are not satisfied by the current spectrum zone configuration for the physical environment; and
modifying the current spectrum zone configuration based on the network requirements.

2. The computer-implemented method of claim 1, wherein a machine learning model that classifies detected human activity based on importance is used to identify the event of interest in the activity data.

3. The computer-implemented method of claim 1, wherein a machine learning model that predicts an impact of a modification to a wireless network is used to determine that the network requirements are not satisfied by the current spectrum zone configuration.

4. The computer-implemented method of claim 1, wherein the spectrum zone configuration includes one or more of a direction of an antenna and an output power level of an antenna.

5. The computer-implemented method of claim 1, wherein the capturing the activity data in the physical environment further comprises:
monitoring the physical environment with a microphone; and
identifying an audio cue in the physical environment, wherein the audio cue is selected from a group consisting of: one or more spoken keywords and acoustic vibrations from user movements.

6. The computer-implemented method of claim 1, wherein the capturing the activity data in the physical environment further comprises:
monitoring the physical environment with a camera; and
identifying a visual cue in the physical environment, wherein the visual cue is selected from a group consisting of: a user movement, a movement of an object, and text displayed in captured video.

7. The computer-implemented method of claim 1, wherein the network requirements include an increase in consumption of network resources above a threshold, wherein the increase is caused by one or more of: a scheduled event and user activity.

8. A computer system for providing differentiated services to spectrum zones based on user activity, comprising:
one or more processors, one or more computer-readable memories, one or more computer-readable tangible storage media, and program instructions stored on at least one of the one or more tangible storage media for execution by at least one of the one or more processors via at least one of the one or more memories, wherein the computer system is capable of performing a method comprising:
obtaining a current spectrum zone configuration for a physical environment from a server;
capturing activity data from the physical environment;
identifying an event of interest in the activity data, wherein the event of interest comprises network requirements;
determining that the network requirements of the event of interest are not satisfied by the current spectrum zone configuration for the physical environment; and
modifying the current spectrum zone configuration based on the network requirements.

9. The computer system of claim 8, wherein a machine learning model that classifies detected human activity based on importance is used to identify the event of interest in the activity data.

10. The computer system of claim 8, wherein a machine learning model that predicts an impact of a modification to a wireless network is used to determine that the network requirements are not satisfied by the current spectrum zone configuration.

11. The computer system of claim 8, wherein the spectrum zone configuration includes one or more of a direction of an antenna and an output power level of an antenna.

12. The computer system of claim 8, wherein the capturing the activity data in the physical environment further comprises:
monitoring the physical environment with a microphone; and
identifying an audio cue in the physical environment, wherein the audio cue is selected from a group consisting of: one or more spoken keywords and acoustic vibrations from user movements.

13. The computer system of claim 8, wherein the capturing the activity data in the physical environment further comprises:
monitoring the physical environment with a camera; and
identifying a visual cue in the physical environment, wherein the visual cue is selected from a group consisting of: a user movement, a movement of an object, and text displayed in captured video.

14. The computer system of claim 8, wherein the network requirements include an increase in consumption of network resources above a threshold, wherein the increase is caused by one or more of: a scheduled event and user activity.

15. A computer program product for providing differentiated services to spectrum zones based on user activity, comprising:
a computer readable storage device having program instructions embodied therewith, the program instructions executable by a processor to cause the processor to perform a method comprising:
obtaining a current spectrum zone configuration for a physical environment from a server;
capturing activity data from the physical environment;
identifying an event of interest in the activity data, wherein the event of interest comprises network requirements;
determining that the network requirements of the event of interest are not satisfied by the current spectrum zone configuration for the physical environment; and
modifying the current spectrum zone configuration based on the network requirements.

16. The computer program product of claim 15, wherein a machine learning model that classifies detected human activity based on importance is used to identify the event of interest in the activity data.

17. The computer program product of claim 15, wherein a machine learning model that predicts an impact of a modification to a wireless network is used to determine that the network requirements are not satisfied by the current spectrum zone configuration.

18. The computer program product of claim 15, wherein the spectrum zone configuration includes one or more of a direction of an antenna and an output power level of an antenna.

19. The computer program product of claim 15, wherein the capturing the activity data in the physical environment further comprises:
monitoring the physical environment with a microphone; and
identifying an audio cue in the physical environment, wherein the audio cue is selected from a group consisting of: one or more spoken keywords and acoustic vibrations from user movements.

20. The computer program product of claim 15, wherein the capturing the activity data in the physical environment further comprises:
monitoring the physical environment with a camera; and
identifying a visual cue in the physical environment, wherein the visual cue is selected from a group consisting of: a user movement, a movement of an object, and text displayed in captured video.
